(19) United States
(12) Patent Application Publication
(10) Pub. No.: US 2025/0113040 A1
(43) Pub. Date: Apr. 3, 2025

(54) VIDEO RESOLUTION SWITCHING ALGORITHM FOR NETWORK STREAMING APPLICATIONS

(71) Applicant: Sony Interactive Entertainment Inc., Tokyo (JP)

(72) Inventor: Hung-Ju Lee, San Mateo, CA (US)

(21) Appl. No.: 18/477,368

(22) Filed: Sep. 28, 2023

(51) Int. Cl. H04N 7/01; H04N 19/147; H04N 19/154

(52) U.S. Cl. CPC H04N 7/0117; H04N 19/147; H04N 19/154

(57) ABSTRACT

Techniques are described for identifying a switching point at which to switch resolutions of a video during streaming due to changing network bitrates. First quality metrics at plural bitrates are determined between selected videos and respective output videos derived from compressing and decompressing the respective selected videos. Also, second quality metrics at plural bitrates are determined between the respective selected videos and upscaled videos generated by upscaling the output video. Using the first and second quality metrics and bitrates, the switching point to change resolution during streaming is identified.

### FIELD

The present application relates to technically inventive, non-routine solutions that are necessarily rooted in computer technology and that produce concrete technical improvements, and more specifically to video resolution switching algorithms for network streaming applications.

### BACKGROUND

In video/game streaming applications over networks, a constant bandwidth is not always guaranteed.

### SUMMARY

As understood herein, during a low latency streaming application, an adaptive adjustment in resolution, frame rate or their combinations is needed to provide uninterrupted service without sacrificing user experience. For example, network bandwidth could be suddenly largely reduced for an unexpended event or overloaded. Under such a circumstance, a 4K streaming service could be adjusted by switching the resolution to a 2K resolution, or even smaller, so that an end user still experiences good quality of service by upscaling the receiving resolution to 4K without or lesser quality loss virtually.

Present principles address the above problem and provide a systematic approach to find out the bitrate switching point where a resolution should be adjusted to accommodate the underlying network conditions.

Accordingly, an apparatus includes at least one processor assembly configured to, for each of at least some of plural selected resolutions, for each of at least some of plural bitrates for each resolution, compress at least some of plural selected videos to render compressed selected videos. The processor assembly is configured to decompress each compressed selected video to generate a respective output video, and determine at least one quality metric between each selected video and respective output video for respective bitrates. The processor assembly further is configured to, at least in part based on the quality metrics and bitrates, generate a first data structure.

Moreover, the processor assembly is configured to, for each of at least some of plural selected resolutions, for each of at least some of plural bitrates for each resolution, upscale at least some of the output videos to render upscaled videos. The processor assembly is configured to, for each upscaled video, calculate at least one quality metric for respective bitrates between the respective selected video and the respective upscaled video, and at least in part based on the quality metrics between the respective selected video and the respective upscaled video and respective bitrates, generate a second data structure.

The processor assembly is configured to, at least in part using the first and second data structures, identify a switching point for switching resolution of a streamed video, and using the switching point, change a resolution of a streamed video.

In some examples, the first and second data structures include rate distortion (RD) curves. In some examples, the first and second data structures include respective equations fitted to respective rate distortion (RD) curves.

In example implementations the processor assembly may be configured to, at least in part using the first and second data structures, identify a switching point for switching resolution of a streamed video by identifying an intersection between the two data structures as the switching point.

In non-limiting embodiments the quality metric can include peak signal-to-noise ratio (PSNR). In other embodiments the quality metric can include structural similarity index (SSIM).

If desired, the processor assembly may be configured to generate the first data structure using averages based on the bit rates. Similarly, the processor assembly may be configured to generate the first data structure using averages based on the quality metrics.

In another aspect, an apparatus includes at least one computer medium that is not a transitory signal and that in turn includes instructions executable by at least one processor assembly to establish, at a first time, a first resolution for at least a first video for streaming based at least in part on a network bitrate meeting a threshold. The instructions are executable to establish, at a second time following the first time, a second resolution for at least the first video for streaming based at least in part on the network bitrate not meeting the threshold, with the second resolution being lower than the first resolution. Further, the instructions are executable to establish, at a third time following the second time, a third resolution for at least the first video for streaming based at least in part on the network bitrate being less than the network bitrate at the second time, with the third resolution being lower than the second resolution. The instructions are executable to establish, at a fourth time following the third time, the second resolution for at least the first video for streaming based at least in part on the network bitrate being greater than the network bitrate at the third time.

In another aspect, a method includes determining first quality metrics at plural bitrates between selected videos and respective output videos derived from compressing and decompressing the respective selected videos. The method also includes determining second quality metrics at plural bitrates between the respective selected videos and upscaled videos generated by upscaling the output videos. The method includes, at least in part using the first and second quality metrics and bitrates, identifying a switching point to change resolution of at least a first video during streaming thereof.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates a diagram of a system consistent with present principles;

FIG. 3 illustrates a graph showing bitrate and resolution with respect to time;

FIG. 4 illustrates example logic in example flow chart format for a first step;

FIG. 5 illustrates example logic in example flow chart format for a second step;

FIG. 6 is a table illustrating results of the first step;

FIG. 7 is part 1 of a table illustrating further results of the first step;

FIG. 8 is part 2 of the table shown in FIG. 7;

FIG. 9 is a table further illustrating results of the first step;

FIG. 10 is a table summarizing the preceding tables;

FIG. 11 illustrates a graph of the rate distortion (RD) curve associated with the first step;

FIG. 12 is table illustrating results of the second step; and

FIG. 13 illustrates a graph showing the intersection of the curves from the first and second steps.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

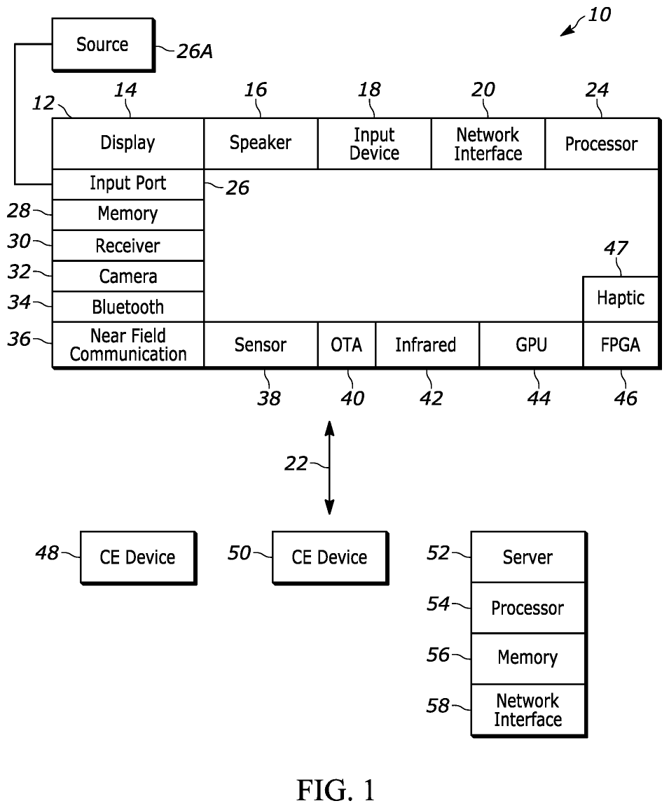

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

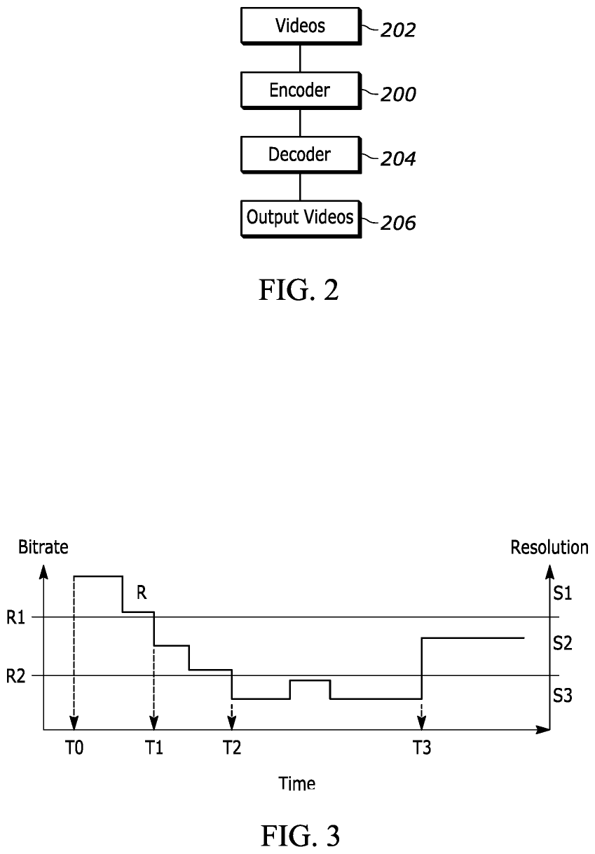

FIG. 2 illustrates a system that includes a video encoder 200 for encoding/compressing videos 202. A video decoder 204 can receive the encoded videos and decode/decompress them into output videos 206.

FIG. 3 illustrates a scenario of how an example of resolution switching operates. At time T0, the network bitrate R>R1, then the video resolution is S1. At time T1, the network bitrate is below R1 (i.e., R<R1), then the resolution S2, where S2<S, is selected for encoding. At time T2, the network bitrate is further reduced to be lower than R2, then the resolution S3 (<S2) is selected for encoding. At time T3, the network bitrate increases and is >R2, then a larger resolution S2 is selected for encoding. R1 and R2 in this chart are designated bitrates at which a video resolution switching occurs, and a proposed algorithm is described below to derive those bitrates.

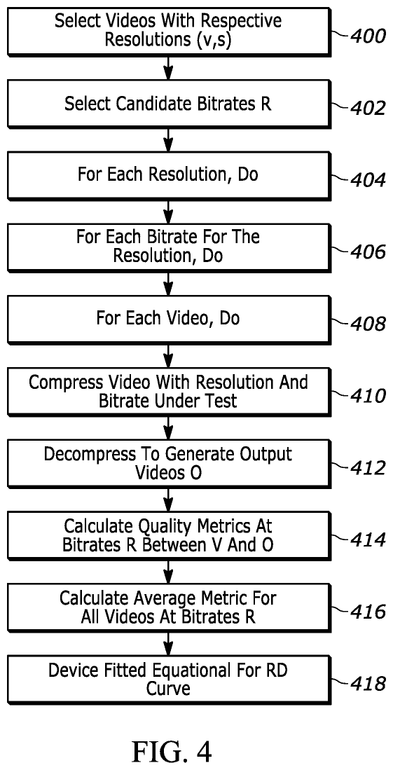

The ultimate goal for the proposed resolution switcher is to provide end users the good quality of service without experiencing unpleasant visual quality degradation. In one implementation, the resolution switcher can be designed into two parts. The first part is a regular Rate-Distortion (RD) derivation, as described below and as shown in FIG. 4.

At state 400, “p” representative videos “V” are selected, V_{k, k=1 . . . p}, with different resolutions “S”, S₁, S₂, . . . , Sₖ, (S₁>S₂> . . . >Sₘ) in one example switch design.

The pseudo-code below is now cross-referenced with the logic state in FIG. 4. At state 402, representative bitrates “R” are selected, R₁, R₂, . . . , Rₘ (R₁>R₂> . . . >Rₙ) for expected or anticipated network conditions. Then a nested “DO” loop is entered:
State 404 for each selected resolution S_{i,i=1 . . . m}
   State 406 for each selected bitrate R_{j, j=1 . . . n}
      State 408 for each selected video V_{k, k=1 . . . p}
         State 410 compress the selected video Vₖ with selected resolution Sᵢ and bitrate Rⱼ
         State 412 decompress the bitstreams to reconstructed output videos Oₖ
         State 414 calculate the visual quality metric at bitrates Rⱼ between selected video Vₖ and output video Oₖ
   State 416 calculate average quality metrics for all videos at bitrates Rⱼ

Thus the quality metrics are computed for all videos at all resolution and bitrates.

State 418 indicates that a first fitted equation E₁ is derived to best describe the RD curve. Note that the quality metric can be an objective measurement such as peak signal-to-noise ratio (PSNR) or structural similarity index (SSIM), or a subjective measurement such as mean opinion score (MOS). The RD curve of the source videos is available.

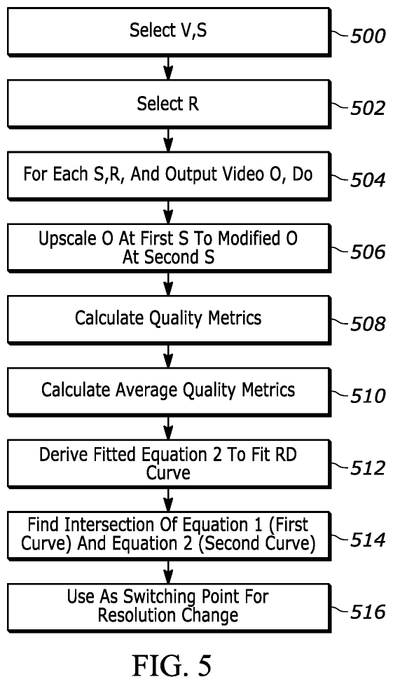

The first step in the example implementation having now been described, attention is turned to FIG. 5 for an understanding of the second step, which finds the RD curve of the “upscaled-up” visions of output videos “O”. For an output video Oₖ₋₁, its scaled-up version is denoted as O″ₖ₋₁, and the resolution of O″ₖ₋₁ is the same as that of Oₖ. For example, if the resolution S₂ of O₂ is 1920×1080, then the resolution of its scaled-up version O″₂ is 3840×2160, which is the same resolution S₁ as O₁ and V₁ as well. Then the quality metric is calculated between O″₂ and V₁. Note that any common scale-up algorithm is applicable in this case, but the most desirable one would be the one used in the receiving end to “perfectly” match the actual use cases.

Commencing at state 500, “p” representative videos V_{k, k=i . . . p} are selected, with different resolutions S₂, . . . , Sₖ, (S₂> . . . >Sₘ) being selected for the switcher design part 2. At state 502, representative bitrates R₁, R₂, . . . , Rₘ (R₁>R₂> . . . >Rₙ) for network conditions are selected.
State 504 indicates a nested “DO” loop in which
For each selected resolution S_{i, i=2 . . . m}
   For each selected bitrate R_{j, j=1 . . . n}
      For each selected reconstructed output video O_{k, k=1 . . . p} from FIG. 4
         State 506 upscale the output video under test Oₖ at resolution Sᵢ to O″ₖ at resolution Sᵢ₋₁ (i.e., from Sᵢ to Sᵢ₋₁, e.g., from 1080p to 2160p)
         State 508 calculate quality metrics at bitrates Rⱼ between the selected video Vₖ at resolution Sᵢ₋₁ and the upscaled output video O″ₖ at resolution Sᵢ₋₁
      State 510 calculate average quality metrics for all reconstructed output videos at bitrates Rⱼ

The quality metrics are computed for all reconstructed output videos at all resolution and bitrates. At state 512, a second fitted equation E₂ is derived to best describe the RD curve produced from FIG. 5. After the first and second equations E₁ and E₂ are derived, the final step is to find out their intersection point at state 514, which may be used at state 516 as a best switching point of resolution change. It is to be understood that the intersection of the two equations describing the RD curves, or the graphical intersection between the curves themselves, may be used to identify the switching point.

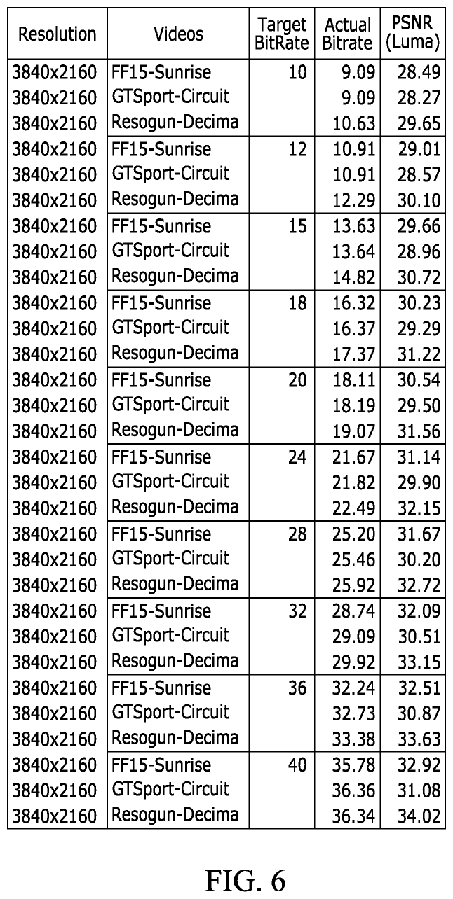

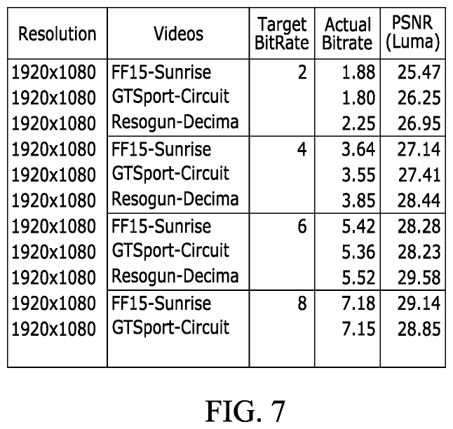

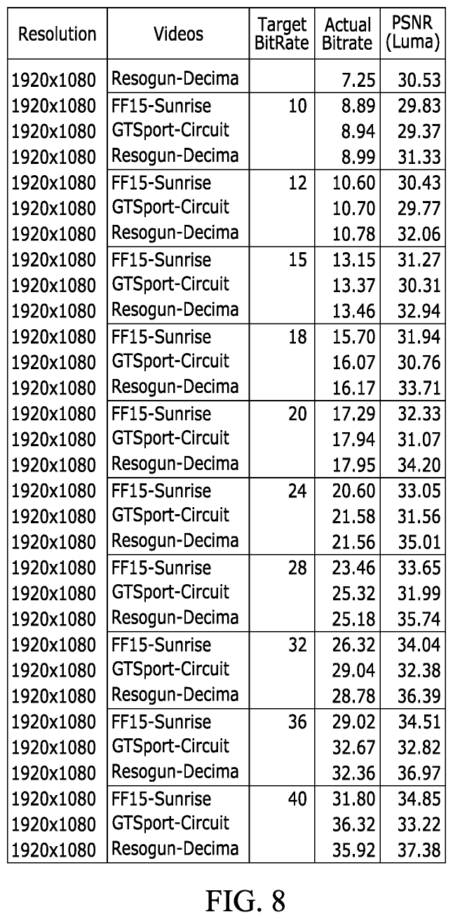

FIGS. 6-9 illustrate in tabular form the results of the logic of FIG. 4 for three respective resolutions (FIGS. 7 and 8 are part of the same table). The first column shows the resolution “S” for the particular figure, the second column lists the three selected videos “V”, and the third column shows the target bites rates “R”. The fourth column shows the actual bit rates, while the fifth column shows the quality metric, in the example shown, PSNR.

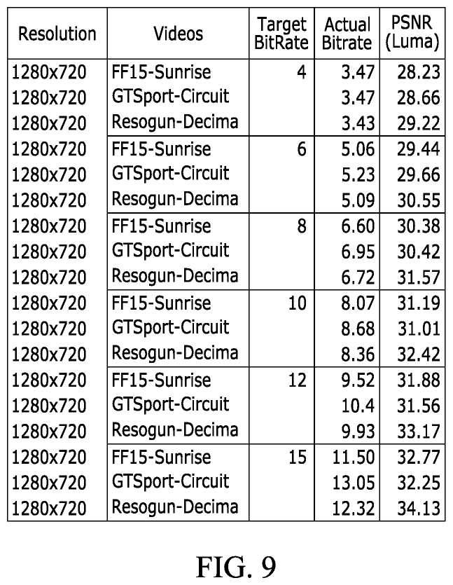

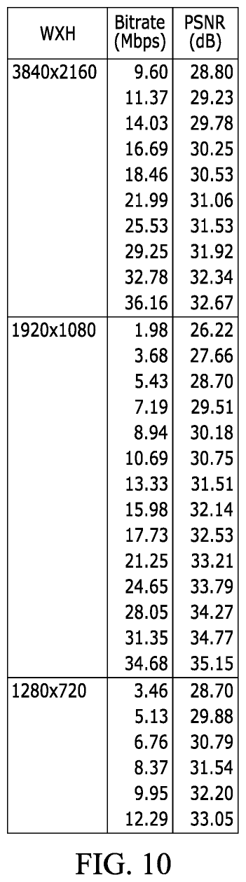

As indicated in FIGS. 6-9, three videos are selected, including FF15-Sunrise, GTSport-Circuit and Resogun-Decima. Three different resolutions are 3840×2160 with ten different bitrates (FIG. 6), 1920×1080 with eleven different bitrates (FIGS. 7 and 8), and 1280×720 with six different bitrates (FIG. 9). FIG. 10 summarizes FIGS. 6-9 by showing the resolutions “S” in the first column with associated average actual bitrates “R” in the second column and average quality metrics in the third column.

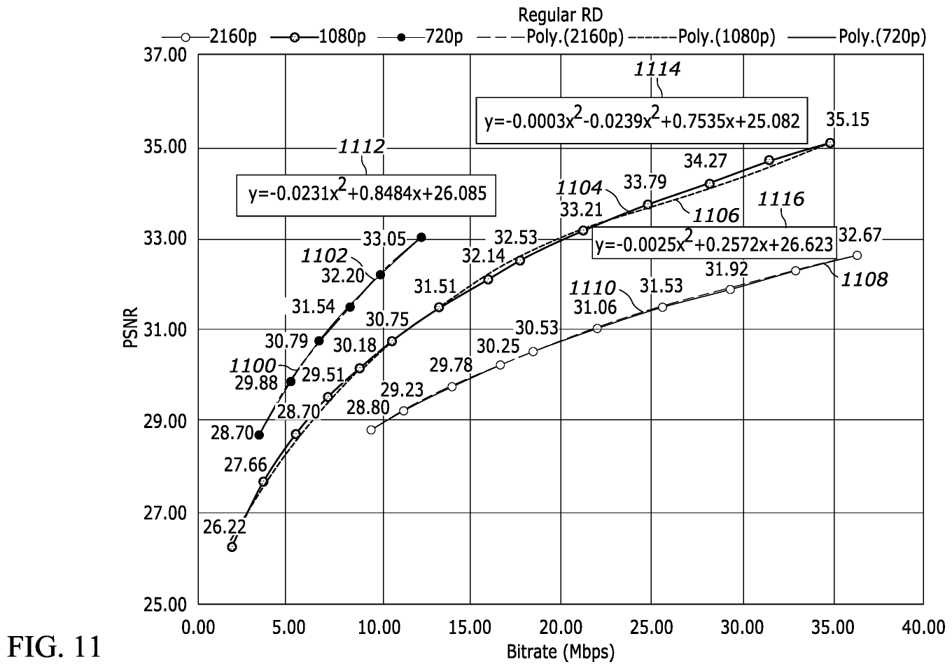

FIG. 11 illustrates the RD curves for the three resolutions shown in FIGS. 6-9 and summarized in FIG. 10, obtained by plotting the average quality metric on the y-axis against the corresponding average actual bitrates on the x-axis. Specifically, the first curve 1100 in FIG. 11 illustrates the RD curve for resolution 720p, with a corresponding fitted equation curve 1102 (denoted in dash line) with an example polynomial approximation with order of two. Likewise, a second curve 1104 in FIG. 11 illustrates the RD curve for resolution 1080p, with a corresponding fitted equation curve 1106 (denoted in dash line) with a polynomial approximation with order of two. Similarly, a third curve 1108 in FIG. 11 illustrates the RD curve for resolution 2160p, with a corresponding fitted equation curve 1110 (denoted in dash line) with a polynomial approximation with order of two. The respective actual fitted equations for the curves 1102, 1106, and 1110 are shown at 1112, 1114, and 1116.

Note that any fitted equation can be applied as long as its error is acceptable.

As indicated above, once the RD curves with fitted equations are determined according to FIG. 4, the logic of Figure implements the second step to find out the RD curve for upscaled date from the generated videos “O”, e.g., 2160p data from 1080p data. As discussed, the quality measurement is obtained by scaling up the output 1080p videos “O” to 2160p (O″) by an upscaled algorithm, then calculating a quality metric such as PSNR and/or SSIM between the upscaled 2160p videos O″ and the native 2160p source videos “V”. Any scaling algorithm, e.g., a bilinear or a bicubic, may be used. In one embodiment, the so-called Lanczos algorithm may be is used.

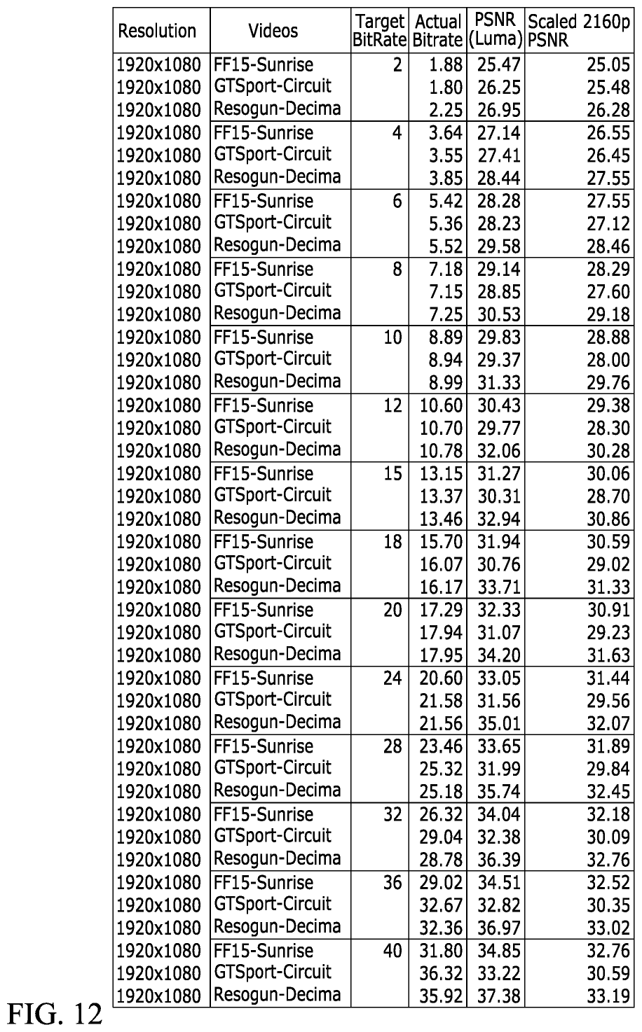

FIG. 12 illustrates the results of FIG. 5. In FIG. 12, the first column illustrates the resolution, the second column illustrates the specific videos, the third column shows the target bitrates, the fourth column shows the actual bitrates achieved, the fifth column shows the corresponding quality metrics, and the sixth column shows the corresponding quality metrics of the upscaled videos.

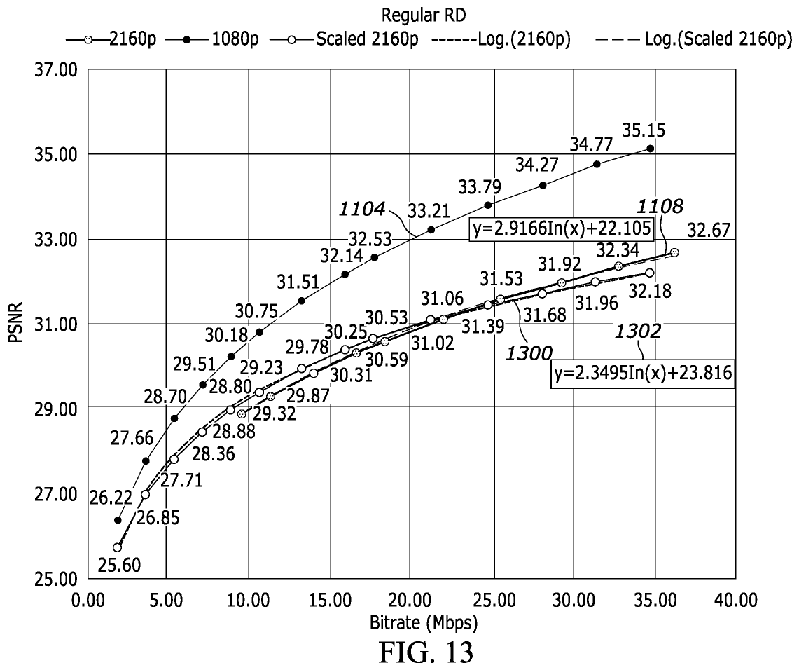

FIG. 13 illustrates the approximation equation of native 2160p at 1108, the native 1080p at 1104, and the scaled 2160p RD curve at 1300 along with its fitted equation at 1302.

The fitted equation for the native 2160p curve from FIG. 4 is E(native 2160p)=2.9166*ln(bitrate)+22.105, while the fitted equation for the scaled 1260 curve from FIG. 5 is E(scaled 2160p)=2.3495*ln(bitrate)+23.816.

Then the intersection point between these two equations indicates the key switching point in bitrate between native 2160p and scaled 4K (i.e., native 1080p). In our example, the intersection point is about 20.5 Mbps, meaning that for the bitrate less than 20.5 Mbps, a native 1080p output video shows better quality (such as PNSR) after it is scaled up to 2160p at the receiving side. On the other hand, for the bitrate larger than 20.5 Mbps, a native 2160p output is preferred. This bitrate is translated to be 22.96 Mbps for the target bitrate.

While particular techniques are herein shown and described in detail, it is to be understood that the subject matter which is encompassed by the present application is limited only by the claims.

What is claimed is:

1. An apparatus comprising:
at least one processor assembly configured to:
for each of at least some of plural selected resolutions, for each of at least some of plural bitrates for each resolution, compress at least some of plural selected videos to render compressed selected videos;
decompress each compressed selected video to generate a respective output video;
determine at least one quality metric between each selected video and respective output video for respective bitrates;
at least in part based on the quality metrics and bitrates, generate a first data structure;
for each of at least some of plural selected resolutions, for each of at least some of plural bitrates for each resolution, upscale at least some of the output videos to render upscaled videos;
for each upscaled video calculate at least one quality metric for respective bitrates between the respective selected video and the respective upscaled video;
at least in part based on the quality metrics between the respective selected video and the respective upscaled video and respective bitrates, generate a second data structure;
at least in part using the first and second data structures, identify a switching point for switching resolution of a streamed video; and
using the switching point, change a resolution of a streamed video.

2. The apparatus of claim 1, wherein the first and second data structures comprise rate distortion (RD) curves.

3. The apparatus of claim 1, wherein the first and second data structures comprise respective equations fitted to respective rate distortion (RD) curves.

4. The apparatus of claim 1, wherein the processor assembly is configured to, at least in part using the first and second data structures, identify a switching point for switching resolution of a streamed video by identifying an intersection between the two data structures as the switching point.

5. The apparatus of claim 1, wherein the quality metric comprises peak signal-to-noise ratio (PSNR).

6. The apparatus of claim 1, wherein the quality metric comprises structural similarity index (SSIM).

7. The apparatus of claim 1, wherein the processor assembly is configured to generate the first data structure using averages based on the bit rates.

8. The apparatus of claim 1, wherein the processor assembly is configured to generate the first data structure using averages based on the quality metrics.

9. An apparatus comprising:
at least one computer medium that is not a transitory signal and that comprises instructions executable by at least one processor assembly to:
establish, at a first time, a first resolution for at least a first video for streaming based at least in part on a network bitrate meeting a threshold;
establish, at a second time following the first time, a second resolution for at least the first video for streaming based at least in part on the network bitrate not meeting the threshold, the second resolution being lower than the first resolution;
establish, at a third time following the second time, a third resolution for at least the first video for streaming based at least in part on the network bitrate being less than the network bitrate at the second time, the third resolution being lower than the second resolution; and
establish, at a fourth time following the third time, the second resolution for at least the first video for streaming based at least in part on the network bitrate being greater than the network bitrate at the third time.

10. The apparatus of claim 9, wherein the instructions are executable to:
switch resolutions at switching points determined using an intersection between first and second data structures.

11. The apparatus of claim 10, wherein the instructions are executable to determine the intersection at least in part by:
for each of at least some of plural selected resolutions, for each of at least some of plural bitrates for each resolution, compress at least some of plural selected videos to render compressed selected videos;
decompress each compressed selected video to generate a respective output video;
determine at least one quality metric between each selected video and respective output video for respective bitrates;
at least in part based on the quality metrics and bitrates, generate a first data structure;
for each of at least some of plural selected resolutions, for each of at least some of plural bitrates for each resolution, upscale at least some of the output videos to render upscaled videos;
for each upscaled video calculate at least one quality metric for respective bitrates between the respective selected video and the respective upscaled video;
at least in part based on the quality metrics between the respective selected video and the respective upscaled video and respective bitrates, generate a second data structure;
at least in part using the first and second data structures, identify the switching point.

12. The apparatus of claim 11, wherein the first and second data structures comprise rate distortion (RD) curves.

13. The apparatus of claim 11, wherein the first and second data structures comprise respective equations fitted to respective rate distortion (RD) curves.

14. The apparatus of claim 11, wherein the quality metric comprises peak signal-to-noise ratio (PSNR).

15. The apparatus of claim 11, wherein the quality metric comprises structural similarity index (SSIM).

16. A method comprising:
determining first quality metrics at plural bitrates between selected videos and respective output videos derived from compressing and decompressing the respective selected videos;
determining second quality metrics at plural bitrates between the respective selected videos and upscaled videos generated by upscaling the output videos; and
at least in part using the first and second quality metrics and bitrates, identifying a switching point to change resolution of at least a first video during streaming thereof.

17. The method of claim 16, comprising using the switching point to switch resolution of the first video while streaming the first video.

18. The method of claim 16, comprising identifying the switching point by identifying an intersection between a first rate distortion (RD) data structure derived from the first quality metrics and a second RD data structure derived from the second quality metrics.

19. The method of claim 18, wherein the first and second RD data structures comprise rate distortion (RD) curves.

20. The method of claim 18, wherein the first and second RD data structures comprise respective equations fitted to respective rate distortion (RD) curves.
